(19) United States
(12) Patent Application Publication
(10) Pub. No.: US 2007/0158167 A1
(43) Pub. Date: Jul. 12, 2007

(54) BELT CONVEYORS CONVERTED FROM SKATE-WHEEL CONVEYORS

(75) Inventor: Andrew A. Corley, Harahan, LA (US)

Correspondence Address: LAITRAM, L.L.C.;LEGAL DEPARTMENT, 220 LAITRAM LANE, HARAHAN, LA, 70123, US

(73) Assignee: LAITRAM, L.L.C., Harahan, LA (US)

(21) Appl. No.: 11/306,689

(22) Filed: Jan. 6, 2006

(51) Int. Cl. B65G 21/00

(52) U.S. Cl. 198/841; 198/860.1

(57) ABSTRACT

A skate-wheel conveyor converted into a belt conveyor, a kit including components for the conversion, and a method for carrying out the conversion. C-shaped collars having an open neck are slipped onto the skate wheels of an existing skate-wheel conveyor. The gap across the neck is narrower than the diameter of the skate wheel. Support surfaces at the ends of the C-shaped collars across the gaps support the bases of wear surfaces, such as wear strips, that form a conveyor carryway to support a conveyor belt. Fasteners retain the wear strips in place, bridging the gaps in the collars to surround the skate wheels in a secure connection.

### BACKGROUND

The invention relates to power-driven conveyors and, more specifically, to skate-wheel conveyors converted into belt or chain conveyors.

Both passive and powered skate-wheel conveyors are commonly used, especially in the package-handling industry, to convey packages. Passive skate-wheel conveyors rely on gravity or the force of a push to convey a package. Powered skate-wheel conveyors, in which a motor-driven flat belt is supported directly atop the skate wheels, convey packages on the belt. Typical powered and passive skate-wheel conveyors include a steel, galvanized, or aluminum frame with parallel side walls. Axles supported at opposite ends in the side walls extend across the conveyor at uniform spacings along its length. Skate wheels are mounted on the axles to form laterally spaced rows of wheels along the length of the conveyor. Usually the wheels are staggered on consecutive axles so that the wheels on every other axle are in the same lateral positions.

But skate-wheel conveyors have shortcomings. First, the bearings in skate wheels wear over time, which causes the wheels to roll less easily or to freeze completely. Second, as skate-wheel conveyors age, they can become noisy. Third, because passive skate-wheel conveyors depend on a push to get a package rolling on a horizontal path, there is no guarantee that a package will make it to its intended destination without being stranded. Fourth, in powered conveyors, the long spacing between wheels produces an undulating conveying surface on the belt that can cause conveyed packages with small footprints to topple.

To meet changing conveyance demands, motor-driven belt or chain conveyors often replace skate-wheel conveyors. Motor-driven belt conveyors are less noisy, avoid stranding packages, and are especially helpful in transporting high volumes of packages. In replacing a skate-wheel conveyor with a belt conveyor, it is beneficial to retain as much of the existing skate-wheel conveyor as possible. U.S. Pat. No. 6,269,939 teaches the conversion of a roller conveyor into a belt conveyor through the use of collars that mount on the rollers of the roller conveyor to support wear surfaces forming a carryway for a conveyor belt. But some of the collars shown are hinged and require latches or fasteners to keep the hinges closed. Other collars are open on one side for easy insertion and removal and work well with the extended outer surfaces of roller-conveyor rollers. But the open-ended roller-conveyor collars would not be sufficiently supported on much narrower skate wheels.

Thus, there is a need for a simple and quick way to convert a skate-wheel conveyor into a belt conveyor.

### SUMMARY

This need and other needs are satisfied by a converted belt conveyor embodying features of the invention. One version of the belt conveyor comprises a skate-wheel conveyor that includes a frame having two generally parallel sides supporting axles spaced apart in a conveying direction. Skate wheels are rotatably mounted on the axles in rows extending in the conveying direction. Each of a set of C-shaped collars surrounds a major portion of the circumference of a skate wheel and terminates in support surfaces at opposite ends of the C. The support surfaces define a support-surface plane. One or more wear surfaces, supported on the support surfaces at the support-surface plane, are mounted on the C-shaped collars. A conveyor belt is supported on the one or more wear surfaces for travel in the conveying direction.

Another version of a belt conveyor comprises a skate-wheel conveyor that includes a plurality of skate wheels rotatably mounted in rows extending in a conveying direction. The skate wheels are mounted on spaced apart axles having opposite ends supported in opposite sides of a conveyor frame. C-shaped collars, each having opposite ends forming coplanar support surfaces separated by a gap, are mounted around the skate wheels. The coplanar support surfaces of the collars define a plane at or above a plane above the axles and tangent to the skate wheels. Wear strips are each mounted on the support surfaces of skate wheels in one of the rows. A conveyor belt is supported on the wear strips for travel in the conveying direction.

Yet another version of a converted belt conveyor comprises a conveyor including wheels rotatably mounted on spaced apart axles in rows extending in a conveying direction. The opposite ends of the axles are supported in opposite sides of a conveyor frame. Collars, each having an open neck between opposite ends and an arcuate inner surface, surround major portions of the circumferences of the wheels. Π-shaped wear strips are mounted on the collars and span the open necks across the opposite ends of the collars in the same row to support a conveyor belt for travel in the conveying direction.

According to another aspect of the invention, a C-shaped collar for mounting around a roller-conveyor wheel and supporting a wear surface for a conveyor belt comprises an arcuate interior surface that extends circumferentially more than 180°. The arcuate interior surface conforms to the outer surface of a roller-conveyor wheel. Opposite ends of the C form coplanar support surfaces separated by a gap narrower than the diameter of the conveyor wheel. The support surfaces support a wear surface for a conveyor belt.

According to yet another aspect of the invention, a kit for converting a skate-wheel conveyor into a belt conveyor comprises C-shaped collars and wear strips. Each collar includes an interior surface that extends circumferentially more than 180° and can conform to the outer surface of a skate wheel. Opposite ends of the C form coplanar support surfaces separated by a gap narrower than the diameter of a skate wheel. The wear strips are attachable atop the support surfaces of the collars to form a planar carryway for a conveyor belt.

Still another aspect of the invention provides a method for converting a skate-wheel conveyor into a belt conveyor. The method comprises: mounting collars having open necks and support surfaces at opposite ends of the collar across the open necks around skate wheels arranged in rows along the length of the conveyor; laying wear strips atop the support surfaces at the ends of the collars along the rows to span the necks of the collars and, with the collars, surround the skate wheels; and fastening the wear strips to the collars.

### BRIEF DESCRIPTION OF THE DRAWINGS

These features and aspects of the invention, as well as its advantages, are better understood by reference to the following description, appended claims, and accompanying drawings, in which:

FIG. 1 is an oblique view, partly cut away, of a portion of a skate-wheel conveyor converted into a belt conveyor embodying features of the invention;

FIG. 2 is a view as in FIG. 1 with some of the components removed to show the skate-wheel conveyor structure;

FIG. 3 is a side elevation view of a collar used in the conversion of a conveyor as in FIG. 2;

FIG. 4 is an exploded view showing the conveyor conversion components and how they fit together to make the conveyor of FIG. 1;

FIG. 5 is a cross section of the conveyor of FIG. 1 taken along lines 5-5;

FIG. 6 is an isometric view of a second version of a collar embodying features of the invention and usable in a conveyor as in FIG. 1;

FIG. 7 is an isometric view of a third version of a collar embodying features of the invention and usable in a conveyor as in FIG. 1; and

FIG. 8 is an exploded view illustrating the attachment of the collar of FIG. 7 to a skate wheel.

### DETAILED DESCRIPTION

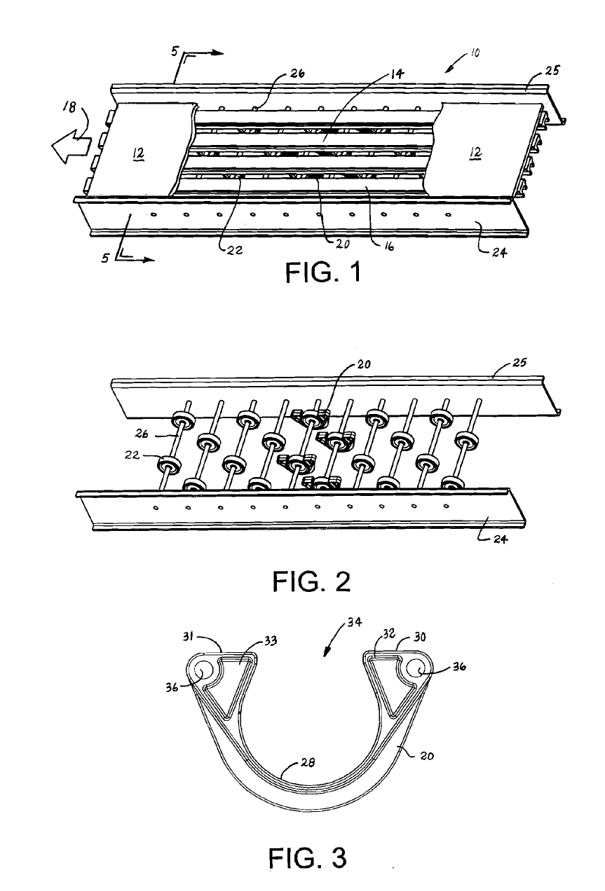

A portion of a skate-wheel conveyor converted into a belt conveyor is shown in FIG. 1. The converted conveyor 10 includes a conveyor belt 12 supported atop a carryway surface 14 formed by the top bearing surfaces of wear strips 16 arranged in rows extending in a conveying direction 18 along the length of the conveyor carryway. The conveyor belt may be a motor-driven flat belt, a modular plastic belt, or a metal belt trained between pulleys or sprockets. The wear strips are supported on collars 20 mounted on skate wheels 22. As better shown in FIG. 2, a skate-wheel frame includes parallel side rails 24, 25 that support the opposite ends of laterally oriented axles 26 spaced apart regularly along the length of the conveyor. The skate wheels are mounted on the axles for rotation. The skate wheels are conventionally staggered laterally from axle to axle to allow for closer positioning of the wheels. The wheels on every other axle are generally positioned at identical lateral distances from the side rails to form laterally spaced rows of wheels extending in the conveying direction.

As shown in FIG. 3, the collar 20 is a C-shaped band with an arcuate inner surface 28 that conforms to the periphery of a skate wheel. Support surfaces 30, 31 at the ends 32, 33 of the C are generally coplanar. The ends of the collar form an open neck 34 with a gap preferably narrower than the diameter of the skate wheels. In this way, the collar will stay on a skate wheel during installation or servicing, even when the wear strip is removed. The inner surface of the collar extends circumferentially more than 180° over a major portion of the skate wheel's periphery to ensure that the collar stays on the skate wheel on its own in any orientation. Eyelets 36 formed in the ends of the collar admit fasteners.

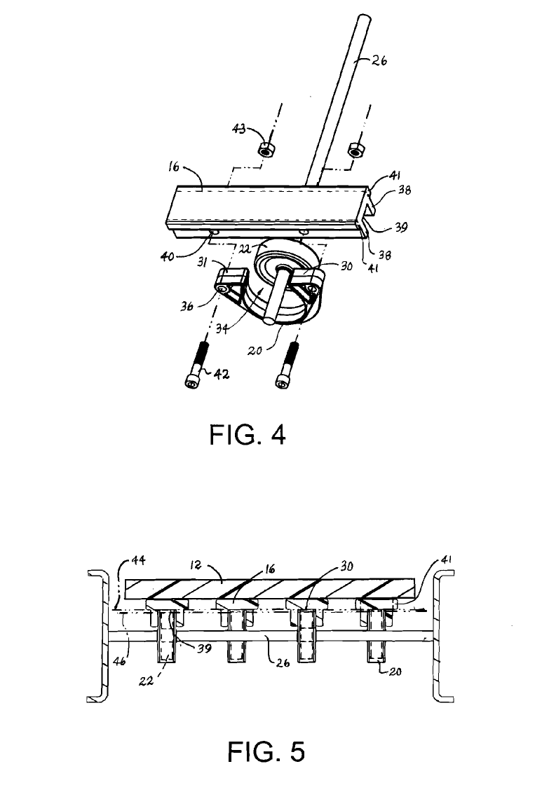

The skate-wheel conveyor is converted into a belt conveyor as shown in FIG. 4. The collar 20 is preferably slipped axially onto the skate wheel from the side. Because the neck 34 of the collar is narrower than the diameter of the skate wheel, the collar is retained loosely on the wheel before the wear strip is attached. Alternatively, the collar can be made resilient enough to open wider at the neck 34 to slip radially over the skate wheel 22 and to relax in snap retention. Preferably, the collar is molded out of a plastic material, such as acetal, polypropylene, or nylon. The wear strip 16, which is π-shaped in cross section, has two depending skirts, or legs 38, spaced apart across a base 39. Holes 40 are formed in the legs in alignment at two locations. The π-shaped wear strip may optionally include ears 41 forming ledges that extend its upper bearing surface. The wear strip, which is preferably made of UHMW plastic for durability and low friction, is laid atop the collar with the wear strip's base resting on the collar's planar support surfaces 30, 31. A fastener, such as a bolt 42 extending through the holes 40 aligned with the collar's eyelets 36 and retained with a nut 43, retains the wear strip in place atop the collars and spans the gap to close the neck of the collar to further keep it in place around the skate wheel. A kit for converting a skate-wheel conveyor into a belt conveyor can be prepared with collars, wear strips, and fasteners. As shown in FIG. 1, the wear strips are arranged linearly along the rows of skate wheels. A single wear strip could run the length of the conveyor carryway on each row or multiple wear strips could be used in each row.

As shown in FIG. 5, the base 39 of the wear strip rests on the support surfaces 30, 31 of the collars. The coplanar support surfaces define a support-surface plane 44 above an imaginary plane 46 tangent to the skate wheels and above the axles.

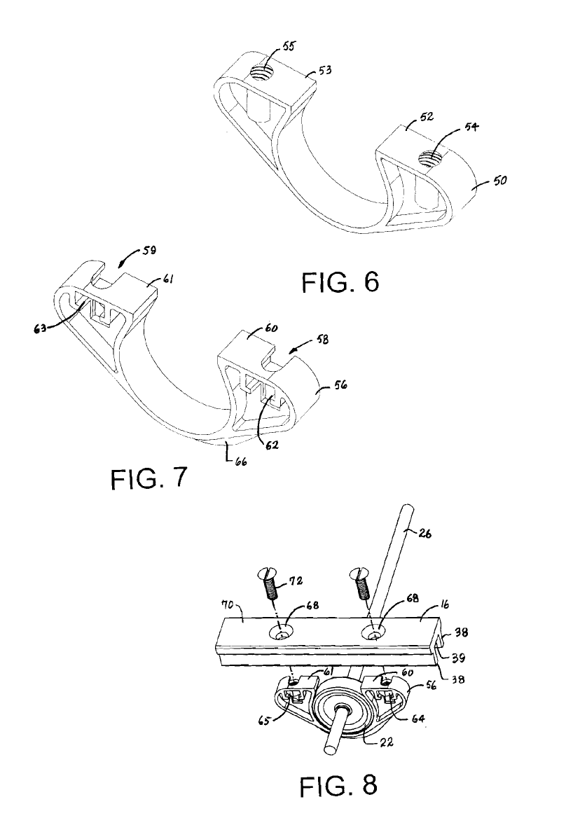

Other versions of collars are shown in FIGS. 6 and 7. The C-shaped collar 50 in FIG. 6 is similar to the collar in FIG. 3. The C terminates at its ends in coplanar support surfaces 52, 53, on which wear strip undersurfaces rest. But, instead of eyelets extending through the ends of the collar parallel to the plane of the support surfaces, the collar has threaded holes 54, 55 opening onto the support surfaces. The threaded holes receive bolts, screws, or other threaded fasteners to attach a wear strip to the collar. The collar 56 in FIG. 7 is another variation of the collar in FIG. 6. This C-shaped collar has slotted openings 58, 59 through support surfaces 60, 61 at the ends of the C. Receptacles 62, 63 receive nuts 64, 65, as shown in FIG. 8. A thin ridge 66 along the outer periphery of the collar adds durability to the otherwise thin portion of the collar opposite the open ends of the C. As shown in FIG. 8, the collar 56 encircles a major portion of the skate wheel 22 and its axle 26. The base 39 of the wear strip 16 rests on the flat support surfaces 60, 61 of the collar. Holes 68 through the wear strip are countersunk into the top conveying surface 70. Flat-head screws 72 are threaded through the holes into the nuts 64, 65 residing in the receptacles 62, 63 to fasten the wear strip to the skate wheel. The depending legs 38 of the π-shaped wear strip extend over the receptacles to retain the nuts. When fastened together, the collar and the wear strip completely surround the skate wheel in a secure attachment. To lessen the chance of damage to a belt mounted on the wear strip in the event that a screw 72 backs out, the screws and their associated nuts are preferably made of nylon.

Thus, the invention provides for the simple, quick, and inexpensive conversion of a skate-wheel conveyor into a belt conveyor.

Although the invention has been described with reference to a few preferred versions, other versions are possible. For example, a continuous wear surface consisting of one or more wide sheets spanning multiple rows of skate wheels can substitute for the linear wear strips. As another example, the inner surface of the collar may have a constant radius of curvature along its entire arc length or may have varying radii or include linear segments. And, although the collars are shown in connection with skate wheels, they would also work to convert roller conveyors into belt conveyors. With roller conveyors, more than one collar could be positioned on each collar; or similar, but wider, collars and wear strips could be used. So, as these few examples suggest, the scope of the invention is not meant to be limited to the details of the preferred versions.

What is claimed is:

1. A belt conveyor converted from a skate-wheel conveyor, the belt conveyor comprising:
a skate-wheel conveyor including a frame having two generally parallel sides supporting a plurality of axles spaced apart in a conveying direction and a plurality of skate wheels rotatably mounted on the axles in rows extending in the conveying direction;
a plurality of C-shaped collars, each collar surrounding a major portion of the circumference of a skate wheel and terminating in support surfaces at opposite ends of the C, wherein the support surfaces define a support-surface plane;
one or more wear surfaces mounted on the C-shaped collars, supported on the support surfaces at the support-surface plane;
a conveyor belt supported on the one or more wear surfaces for travel in the conveying direction.

2. A belt conveyor as in claim 1 wherein the one or more wear surfaces comprise a plurality of π-shaped wear strips, each mounted to the support surfaces of collars in a row.

3. A belt conveyor as in claim 1 wherein the support surfaces are separated across the ends of the C-shaped collar by a gap narrower than the diameter of the skate wheels.

4. A belt conveyor converted from a skate-wheel conveyor, the belt conveyor comprising:
a skate-wheel conveyor including a plurality of skate wheels rotatably mounted in rows extending in a conveying direction on spaced apart axles having opposite ends supported in opposite sides of a conveyor frame;
a plurality of C-shaped collars, each having opposite ends forming coplanar support surfaces separated by a gap and mounted around a skate wheel, wherein the coplanar support surfaces of the plurality of collars define a plane at or above a plane above the axles and tangent to the skate wheels;
a plurality of wear strips, each mounted on the support surfaces of two skate wheels in one of the rows;
a conveyor belt supported on the wear strips for travel in the conveying direction.

5. A belt conveyor as in claim 4 wherein the wear strips are π-shaped in cross section.

6. A belt conveyor as in claim 4 wherein the C-shaped collars include an inner arcuate surface extending circumferentially more than 180° around the skate wheels.

7. A belt conveyor as in claim 4 wherein the gaps of the C-shaped collars installed on the skate wheels are narrower than the diameter of the skate wheels.

8. A belt conveyor as in claim 4 further comprising fasteners and wherein the collars form eyelets extending parallel to the plane of the support surfaces at each end to admit the fasteners to retain the wear strips to the support surfaces.

9. A belt conveyor as in claim 4 further comprising fasteners and wherein the collars form an opening in the support surfaces at each end to admit the fasteners to retain the wear strips to the support surfaces.

10. A belt conveyor as in claim 4 wherein the wear strips, when mounted to the collars, bridge the gaps in the collars.

11. A belt conveyor comprising:
a conveyor including a plurality of wheels rotatably mounted in rows extending in a conveying direction on spaced apart axles having opposite ends supported in opposite sides of a conveyor frame;
a plurality of collars, each having an open neck between opposite ends of the collar and an arcuate inner surface surrounding a major portion of the circumference of a wheel;
a plurality of π-shaped wear strips mounted on the collars and spanning the necks across opposite ends of the collars in the same row;
a conveyor belt supported on the wear strips for travel in the conveying direction.

12. A belt conveyor as in claim 111 further comprising fasteners and wherein the collars form eyelets at each end and the π-shaped wear strips have two legs with aligned holes that are aligned with the eyelets in the collars to admit the fasteners to retain the wear strips to the ends of the collars.

13. A belt conveyor as in claim 11 further comprising fasteners and wherein the collars form an opening at each end and the π-shaped wear strips have a flat top with countersunk holes that align with the openings in the collars to admit the fasteners to retain the wear strips to the ends of the collars.

14. A belt conveyor as in claim 11 wherein the open neck is narrower than the diameter of the wheels.

15. A C-shaped collar for mounting around a roller-conveyor wheel and supporting a wear surface for a conveyor belt, the collar comprising:
an arcuate interior surface extending circumferentially more than 180° and conformable to the outer surface of a roller-conveyor wheel;
opposite ends of the C forming coplanar support surfaces separated by a gap narrower than the diameter of the conveyor wheel, wherein the support surfaces support a wear surface for a conveyor belt.

16. A belt conveyor as in claim 15 further comprising eyelets at each end of the collar.

17. A kit for converting a skate-wheel conveyor into a belt conveyor, the kit comprising:
a plurality of C-shaped collars, each including an interior surface extending circumferentially more than 180° and conformable to the outer surface of a skate wheel and including opposite ends of the C forming coplanar support surfaces separated by a gap narrower than the diameter of a skate wheel; and
a plurality of wear strips attachable atop the support surfaces of the collars to form a planar carryway for a conveyor belt.

18. A method for converting a skate-wheel conveyor into a belt conveyor, the method comprising:
mounting collars having open necks and support surfaces at opposite ends of the collar across the open necks around skate wheels arranged in rows along the length of the conveyor;
laying wear strips atop the support surfaces at the ends of the collars along the rows to span the necks of the collars and, with the collars, surround the skate wheels;
fastening the wear strips to the collars.
